(19) United States
(12) Patent Application Publication
(10) Pub. No.: US 2012/0261412 A1
(43) Pub. Date: Oct. 18, 2012

(54) Ice Bin Container System and Method

(76) Inventor: Jeremy B. Lieb, West Chester, OH (US)

(21) Appl. No.: 13/449,606

(22) Filed: Apr. 18, 2012

Related U.S. Application Data
(60) Provisional application No. 61/476,328, filed on Apr. 18, 2011.

(51) Int. Cl. B65D 21/02; B23P 19/04

(52) U.S. Cl. 220/23.87; 29/428

(57) ABSTRACT

A container may be configured to fit inside a receptacle to facilitate maintenance. The container may be dishwasher safe or disposable and may include a drain mechanism that feeds into a drain of the receptacle. One or more dimensions of the container may be adjusted to fit the receptacle.

### I. CLAIM OF PRIORITY

This application claims priority to U.S. Provisional Patent Application No. 61/476,328, filed on Apr. 18, 2011, which is incorporated by reference herein in its entirety for all purposes.

### II. FIELD OF THE DISCLOSURE

The present disclosure relates generally to ice bins, and more specifically, to the maintenance of ice bins.

### III. BACKGROUND

Ice bins are commonly used in restaurants and bars to store beverages and food products on ice. Ice bins are also used to store ice cubes for drinks. While effective at keeping items cold, the maintenance of ice bins can be problematic. For example, leaked beverage and glass particles resulting from a broken bottle can contaminate all of the ice cubes in the ice bin, as well as the ice bin. Cleaning may involve scooping out all of the ice and wiping down all accessible surfaces inside the ice bin.

### IV. SUMMARY OF THE DISCLOSURE

An embodiment of an apparatus may be used to line drop-in and stand alone ice bins for bars, service bars, and restaurants. The apparatus may be used to efficiently remove ice cubes from the ice bins. An embodiment of the apparatus, or container, may facilitate sanitation procedures in the event that ice cubes become contaminated. Other embodiments may be used for other types of receptacles, such as sinks or other partially enclosed containers having a drain.

An embodiment of the container may be constructed from a material that is dishwasher safe or disposable to allow for a higher level of sanitation maintenance than a conventional ice bin. An embodiment of the apparatus may be made from a material that is food safe and that does not conduct heat.

An embodiment of the container accommodates and works in conjunction with ice bins that include cold plates. The container may fit snuggly or loosely into the ice bin as to substantially prevent contamination from entering the ice bin. The dimensions of the container may be based off of standard ice bin sizes or may loosely fit multiple sizes of ice bins. An embodiment of the container may be adjustable to accommodate different size ice bins. In larger ice bins, one or more container may be used to accommodate the weight and volume of the ice. An ice bin lid may close tightly when the container is seated within the ice bin.

An embodiment of the container may include handles to facilitate access. The container may additionally include a drain mechanism that includes one or more drains. The drain mechanism may drain into the drainage system of the ice bin. As such, the drain mechanism of the container may prevent contaminants to be passed to the ice bin.

In a particular embodiment, an apparatus includes an ice bin and a removable container configured to fit within the ice bin to receive ice cubes. The removable container may include a drain mechanism configured to facilitate the flow of liquid to an existing drain of the ice bin. Where desired, an additional container may be configured to fit within the ice bin. The additional container may be configured to attach to the container. In another embodiment, the additional container is configured to fit within the container.

The container may be constructed from dishwasher safe or disposable material, which may include one or more of plastic, ceramic, and metal. The ice bin may include a cold plate attached to the ice bin. The container may be configured to transfer cold to the ice cubes and may include a contoured dimension configured to fit around the cold plate. The ice bin may include a lid that is configured to close while the container is positioned within the ice bin.

According to another embodiment, an apparatus may include a base structure and a first wall structure that extends in a first direction from the base surface. The first wall structure may include a first inner surface. A second wall structure may extend in the first direction from the base surface and may have a second inner surface. The second inner surface may face the first inner surface. A third wall structure may extend in a first direction from the base surface and may have a third inner surface. A fourth wall structure may extend in the first direction from the base surface and may have a fourth inner surface. The fourth inner surface may face the third inner surface. The base structure, the first wall structure, the second wall structure, the third wall structure, and the fourth wall structure may include a removable container configured to fit inside an ice bin and form an aperture to receive ice cubes.

The apparatus may further include a handle. The handle may be attached to or may be integral with at least one of the first wall structure, the second wall structure, the third wall structure, and the fourth wall structure. The apparatus may further include another handle. The other handle may be least one of attached to and integral with one of the first wall structure, the second wall structure, the third wall structure, and the fourth wall structure. At least one of the first wall structure, the second wall structure, the third wall structure, and the fourth wall structure may include an adjustable length portion. For example, the base structure may include at least one of an adjustable length portion and an adjustable width portion. In another or the same embodiment, at least one of the first wall structure, the second wall structure, the third wall structure, and the fourth wall structure includes at least one of an adjustable length portion and an adjustable width portion. At least one of the base structure, the first wall structure, the second wall structure, the third wall structure, and the fourth wall structure may be formed from an insulating material.

A drain outlet mechanism may be located in at least one of the base structure, the first wall structure, the second wall structure, the third wall structure, and the fourth wall structure. The drain outlet mechanism may include a contoured surface that extends towards the at least one of base structure, first wall structure, second wall structure, third wall structure, and fourth wall structure.

According to another particular embodiment, a method of maintaining an ice bin includes configuring a removable container to fit within the ice bin. The removable container may include a drain mechanism configured to facilitate a flow of a liquid towards a drain of the ice bin. The removable container may be positioned within the ice bin to receive ice. The removable container may further be configured to include an adjustable dimension. Certain embodiments of the container may include a rigid or semi-rigid material.

These and other advantages and features that characterize embodiments are set forth in the claims annexed hereto and forming a further part hereof. However, for a better understanding of the embodiments, and of the advantages and objectives attained through their use, reference should be made to the drawings and to the accompanying descriptive matter in which there are described exemplary embodiments.

### V. BRIEF DESCRIPTION OF THE DRAWINGS

FIG. 1 is a perspective view of an embodiment of a removable ice bin container system configured to be placed inside an ice bin;

FIG. 2 is a cross-sectional view of a structure, such as a wall or a base structure of FIG. 1, configured to enable an adjustment of a dimension of a container; and

FIG. 3 is a flowchart illustrating an embodiment of a method of maintaining an ice bin using a removable ice bin container system.

### VI. DETAILED DESCRIPTION

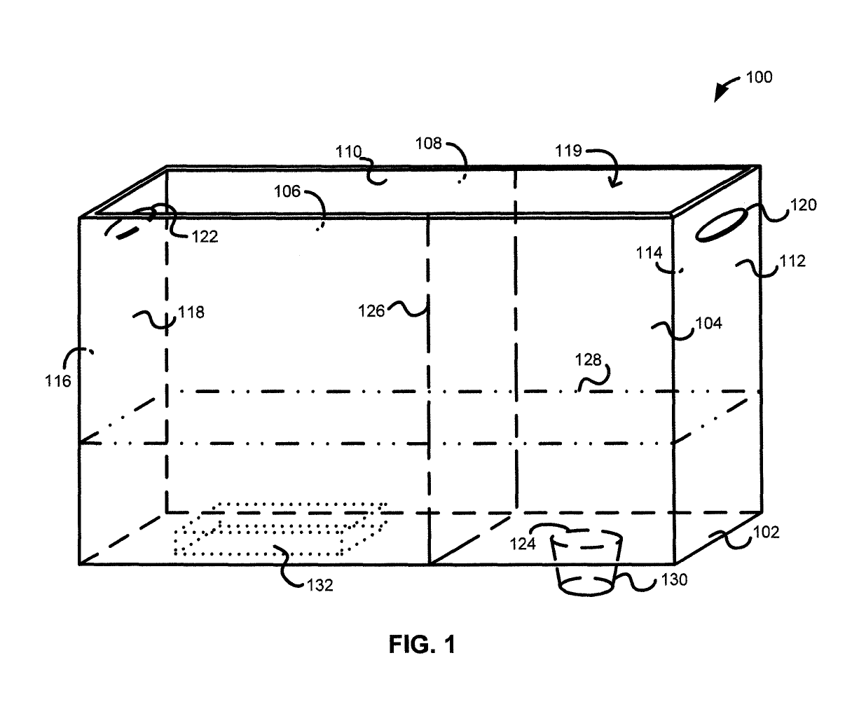

FIG. 1 is a perspective view of an embodiment of a removable container 100 configured to fit within a receptacle, such as an ice bin. More particularly, the container 100 may be configured to rest inside a liner of the ice bin to receive and store ice cubes. The dimensions of the container 100 may be adjusted to fit differently sized ice bin liners, and the container 100 may include a drain outlet mechanism 124 that cooperates with or bypasses the existing drainage system of the ice bin. The container 100 may be removed and washed after use without requiring extensive cleaning of the ice bin.

The container 100 may include a base structure 102 and a first wall structure 104 that extends vertically above the base surface 102. The first wall structure 104 may include a first inner surface 106. A second wall structure 108 may have a second inner surface 110 that faces the first inner surface 106. A third wall structure 112 may have a third inner surface 114, and a fourth wall structure 116 may include a fourth inner surface 118. The fourth inner surface 118 may face the third inner surface 114. An aperture 119 formed at the top of the container 100 is configured to receive ice cubes.

The removable container 100 may be constructed from at least one of a rigid and a semi-rigid material. The container 100 may be constructed from a dishwasher safe material, which may include one or more of plastic, ceramic, metal, and rubber material. The container 100 may be constructed from an insulating material.

The container 100 may further include handles 120, 122. The handles 120, 122 may be attached to or may be integral with the first and second wall structures 112, 116. The handles of another embodiment may protrude inside the container promote a snug fit with the liner of the ice bin.

At least one of the base structure 102, the first wall structure 104, the second wall structure 108, the third wall structure 112, and the fourth wall structure 116 may include an adjustable length portion. For example, the length of the container 100 may be adjusted, as represented by the line 126. In a particular embodiment, the base structure 102, the first wall structure 104, and the second wall structure 108 may each include multiple horizontally oriented portions. A track, or lip mechanism, may enable the horizontally oriented portions to slide past one another to a desired length. The height of the container 100 may be adjusted along the line 128. In another or the same embodiment, the first wall structure 104, the second wall structure 108, the third wall structure 112, and the fourth wall structure 116 may each include multiple vertically oriented portions. A track, or lip mechanism, may enable the vertically oriented portions to slide past one another to a desired height.

The drain mechanism 124 is shown in FIG. 1 as being located in the drain structure. A drain mechanism of another embodiment may additionally or alternatively be located in the first wall structure 104, the second wall structure 108, the third wall structure 112, and the fourth wall structure 116. The drain mechanism 124 may include a contoured surface 130 that extends through the base structure 102. The contoured surface 130 may include a pipe, a hose, or a drain fixture that feeds into the drainage system of the ice bin. The contoured surface 130 may enable water and potential contaminants to bypass the liner of the ice bin. A hole comprising the drain mechanism 124 may be preformed into the base structure 102 or may be cut by a user to mate with the drain of the ice bin. A portion of the drain mechanism 124 may be screwed, glued, or otherwise attached to the container 100.

An embodiment of the container 100 may not constructed from a rigid or a semi-ride material. For example, the container 100 may comprise one or more plastic layers, as in a plastic bag. In such an embodiment, the drain mechanism may comprise a hole punched through the container 100 to feed the flow of liquid into the drain of the ice bin. A reusable or disposable nipple device of the drain mechanism may puncture the container 100 so as to mate or otherwise attach to the drain. Such a nipple device may be constructed from plastic, rubber, ceramic, or metal, and may form a seal or guide to facilitate the flow of liquid out of the container and into the drain of the ice bin. The nipple may be prepackaged with the container 100. A drain mechanism of a container may alternatively be prefabricated such that a baglike container includes a preformed hole. The preformed hole may include a tapered portion for insertion into the drain of the ice bin or other receptacle.

The ice bin may include a cold plate attached to the ice bin. The container 100 may be configured to transfer cold to the ice cubes and may include a contoured dimension 132 configured to fit around the cold plate. The material from which the container 100 is constructed may thus include both thermally conductive and insulating portions. While the dimensions of the container 100 shown in the embodiment of FIG. 1 are rectangular, the dimensions of a container of another embodiment may be curved to fit dimensions of an ice bin. The ice bin may include a lid that is configured to close while the container 100 is positioned within the ice bin. That is, the container 100 is configured to not interfere with the lid closure of the ice bin.

Where desired, an additional container may be configured to fit within the ice bin. The additional container may be configured to attach to or rest next to the container 100. In another embodiment, the additional container is configured to fit within the container 100.

FIG. 1 thus shows an embodiment of a container 100 that may be used to line drop-in and stand alone ice bins for bars, service bars, and restaurants. The container 100 may be used efficiently remove ice cubes from the ice bins. An embodiment of the container 100 may facilitate sanitation procedures in the event that ice cubes become contaminated. An embodiment of the container 100 may be constructed from a material that is dishwasher safe or disposable to allow for a higher level of sanitation maintenance than a conventional ice bin. The container 100 may be made from a material that is food safe and that does not conduct heat. An embodiment of the container 100 accommodates and works in conjunction with ice bins that include cold plates. The container 100 may fit snuggly or loosely into the ice bin so as to substantially prevent contamination from entering the ice bin. An embodiment of the container 100 may include handles to facilitate access. The container 100 may additionally include a drain mechanism that couples to the existing drain system of the ice bin. The dimensions of the container 100 may be based off of standard ice bin sizes. An embodiment of the container 100 may be adjustable to accommodate different size ice bins. In larger ice bins, one or more containers may be used to accommodate the weight and volume of the ice. An ice bin lid may close tightly when the container 100 is seated within the ice bin.

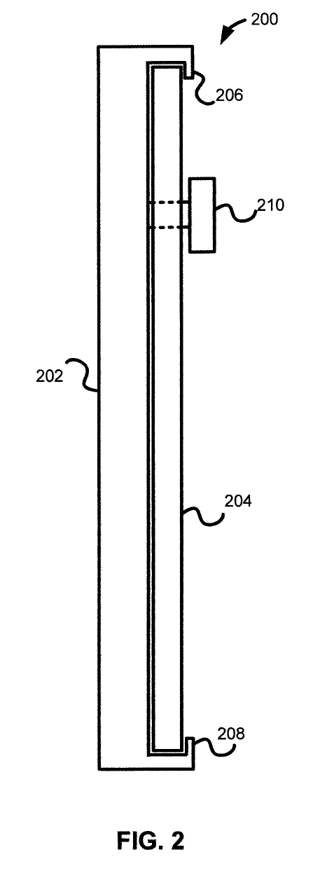

FIG. 2 is a cross-sectional view of a structure 200, such as a wall or a base structure of FIG. 1, configured to enable an adjustment of a dimension of a container. For example, a first portion 202 of the structure 200 may be one of the base structure 102, the first wall structure 104, the second wall structure 108, the third wall structure 112, and the fourth wall structure 116 of FIG. 1. The first portion 202 of FIG. 2 may work in conjunction with a second portion 204 to comprise an adjustable length or height of the structure 200. First and second track, or lip, mechanisms 206, 208 may form a groove that enables the parallel portions 202, 204 to slide past one another a desired distance. The first and second portions 202, 204 may be secured in place by a fastener 210, such as a knob attached to a screw. An adjusted relative orientation of the first and second portions 202, 204 may alternatively remain in place due to friction between the track mechanisms 206, 208 and the first and second portions 202, 204. One skilled in the art will appreciate that the foregoing embodiment is only one mechanism by which the walls and base structures of a container may be adjusted to fit within dimensions of an ice bin.

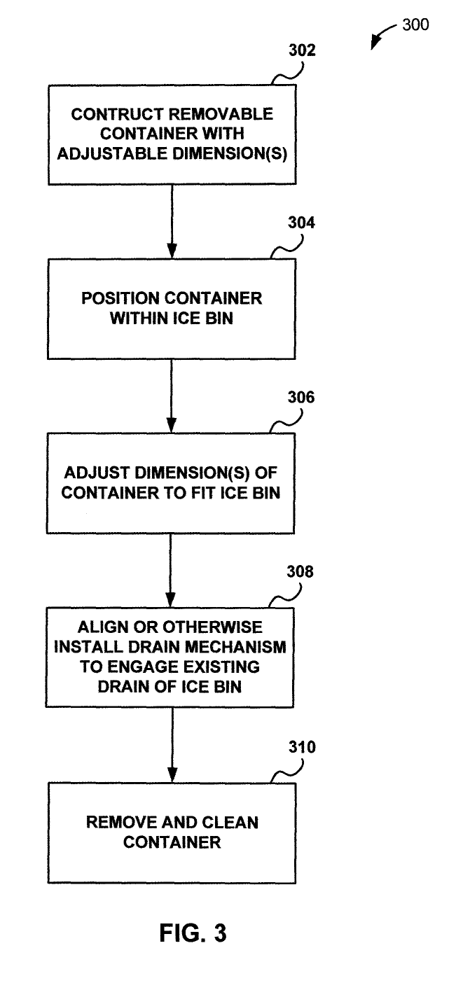

FIG. 3 is a flowchart illustrating an embodiment of a method 300 of maintaining an ice bin using a removable ice bin liner system. According to another particular embodiment, a removable container is constructed at 302 from at least one of a rigid and a semi-rigid material. The container may be dishwasher safe and may include both insulating and conducting materials.

The removable container may be positioned at 304 within the ice bin to receive ice. Handles, such as the handles 120, 122 of the container 100 of FIG. 1, may facilitate placement of the container.

A dimension of the container may be adjusted at 306 to fit the corresponding dimensions of the ice bin. For instance, at least one of the base structure 102, the first wall structure 104, the second wall structure 108, the third wall structure 112, and the fourth wall structure 116 of the container 100 FIG. 1 may include an adjustable length or height portion.

At 308, a drain mechanism of the container may be aligned or otherwise connected to an existing drainage system of the ice bin. For example, the drain mechanism 124 of FIG. 1 may be configured to allow water and contaminants to flow out of the container 100 in a manner that does not contaminate the liner of the ice bin. The container may be removed and cleaned at 310.

While various embodiments have been described in detail, it is not the intention of the Applicant to restrict, or any way limit the scope of the appended claims to such detail. The embodiments in their broader aspects are therefore not limited to the specific details, representative apparatus, method, and illustrative examples shown and described. Accordingly, departures may be made from such details without departing from the spirit or scope of Applicant's general inventive concept.

I claim:

1. An apparatus, comprising:
a base structure;
a first wall structure extending in a first direction from the base surface and having a first inner surface;
a second wall structure extending in the first direction from the base surface and having a second inner surface, wherein the second inner surface faces the first inner surface;
a third wall structure extending in a first direction from the base surface and having a third inner surface; and
a fourth wall structure extending in the first direction from the base surface and having a fourth inner surface, wherein the fourth inner surface faces the third inner surface,
wherein the base structure, the first wall structure, the second wall structure, the third wall structure, and the fourth wall structure comprise a removable container configured to fit inside a receptacle and form an aperture.

2. The apparatus of claim 1, further comprising a handle, wherein the handle is at least one of attached to and integral with one of the first wall structure, the second wall structure, the third wall structure, and the fourth wall structure.

3. The apparatus of claim 2, further comprising another handle, wherein the other handle is at least one of attached to and integral with one of the first wall structure, the second wall structure, the third wall structure, and the fourth wall structure.

4. The apparatus of claim 1, wherein at least one of the first wall structure, the second wall structure, the third wall structure, and the fourth wall structure includes an adjustable length portion.

5. The apparatus of claim 4, wherein base structure includes at least one of an adjustable length portion and an adjustable width portion.

6. The apparatus of claim 1, wherein at least one of the first wall structure, the second wall structure, the third wall structure, and the fourth wall structure includes at least one of an adjustable length portion and an adjustable width portion.

7. The apparatus of claim 1, wherein at least one of the base structure, the first wall structure, the second wall structure, the third wall structure, and the fourth wall structure is formed from an insulating material.

8. The apparatus of claim 1, further comprising a drain outlet mechanism located in at least one of the base structure, the first wall structure, the second wall structure, the third wall structure, and the fourth wall structure is formed from an insulating material.

9. The apparatus of claim 8, wherein the drain outlet mechanism includes a contoured surface that extends towards the at least one of base structure, first wall structure, second wall structure, third wall structure, and fourth wall structure.

10. An apparatus, comprising:
a receptacle;
a removable container configured to fit within the receptacle; and
a drain mechanism configured to facilitate a flow of liquid towards a drain of the receptacle.

11. The apparatus of claim 10, further comprising an additional container configured to fit within the receptacle.

12. The apparatus of claim 11, wherein the additional container is configured to attach to the container,

13. The apparatus of claim 10, further comprising an additional container configured to fit within the container.

14. The apparatus of claim 10, wherein the container is constructed from dishwasher safe material.

15. The apparatus of claim 10, wherein the drain mechanism includes a structure configured to attach to the drain of the receptacle.

16. The apparatus of claim 10, further comprising a cold plate attached to the receptacle, wherein the container is configured to transfer cold to the ice cubes, and wherein the container includes a contoured dimension configured to fit around at least one of the cold plate and another surface of the receptacle.

17. The apparatus of claim 10, wherein the receptacle includes a lid, wherein the lid is configured to close while the container is positioned within the receptacle.

18. The apparatus of claim 10, wherein the container comprises at least one of plastic, ceramic, and metal.

19. A method of maintaining a receptacle, comprising:
configuring a removable container to fit within a receptacle, wherein the removable container includes a drain mechanism configured to facilitate a flow of a liquid towards a drain of the receptacle; and
positioning the removable container within the receptacle to receive ice.

20. The method of claim 19, further comprising configuring at least one dimension of the removable container to be adjustable to fit the receptacle.
